(19) United States
(12) Patent Application Publication
(10) Pub. No.: US 2013/0105567 A1
(43) Pub. Date: May 2, 2013

(54) MEDIA APPARATUS, CONTENT SERVER AND METHOD FOR OPERATING THE SAME

(71) Applicant: Taejoon CHOI, Seoul (KR)

(72) Inventor: Taejoon CHOI, Seoul (KR)

(21) Appl. No.: 13/545,211

(22) Filed: Jul. 10, 2012

(30) Foreign Application Priority Data
Nov. 1, 2011 (KR) 10-2011-0112936

(51) Int. Cl. G06F 17/00

(52) U.S. Cl. 235/375

(57) ABSTRACT

A media apparatus, a content server and a method for operating the same are disclosed. A method for operating a media apparatus includes tagging a media card, receiving content related information from the media card, and displaying a media card list including a media card object corresponding to the content related information of the media card. Therefore, it is possible to increase user convenience.

### CROSS-REFERENCE TO RELATED APPLICATION

This application claims the priority benefit of Korean Patent Application No. 10-2011-0112936, filed on Nov. 1, 2011 in the Korean Intellectual Property Office, the disclosure of which is incorporated herein by reference.

### BACKGROUND OF THE INVENTION

1. Field of the Invention

The present invention relates to a media apparatus, a content server and a method for operating the same, and more particularly to a media apparatus, a content server and a method for operating the same, which are capable of increasing user convenience.

2. Description of the Related Art

A media apparatus processes content data such as video or audio data capable of being viewed or listened to by users. Users may view video data or listen to audio data using the media apparatus.

As the type or amount of content is diversified, various methods considering user convenience when reproducing or outputting content desired by a user have been discussed.

### SUMMARY OF THE INVENTION

Therefore, the present invention has been made in view of the above problems, and it is an object of the present invention to provide a media apparatus, a content server and a method for operating the same, which are capable of increasing user convenience.

An another object of the present invention is to provide a media apparatus, a content server and a method for operating the same, which are capable of conveniently transmitting or receiving content related information using near field communication (NFC).

In accordance with an aspect of the present invention, the above and other objects can be accomplished by the provision of a method for operating a media apparatus, including tagging a media card, receiving content related information from the media card, and displaying a media card list including a media card object corresponding to the content related information of the media card.

In accordance with a further aspect of the present invention, there is provided a method for operating a content server, including receiving a content transmission request from a media apparatus over a network, receiving information regarding a media card capable of communicating with the media apparatus, determining whether content of the media card is available based on the information regarding the media card and transmitting a message indicating that the content is not available to the media apparatus if the content is not available, and transmitting the content to the media apparatus if the content of the media card is available.

In accordance with yet another aspect of the present invention, there is provided a media apparatus including a near field communication module configured to receive content related information of a media card by tagging the media card, and a display configured to display a media card list including a media card object corresponding to the media card.

In accordance with yet another aspect of the present invention, there is provided a content server including a network interface configured to receive a content transmission request from a media apparatus over a network and receive information regarding a media card capable of communicating with the media apparatus, and a processor configured to determine whether content of the media card is available based on the information regarding the media card, transmit a message indicating that the content is not available to the media apparatus if the content is not available, and transmit the content to the media apparatus if the content of the media card is available.

According to the embodiments of the present invention, in a media card data storage mode, content related information received from a media card by NFC is stored and, if a media card list display input is received, a media card list including a media card object corresponding to the media card is displayed, thereby enabling a user to easily use the media card list. Accordingly, it is possible to increase user convenience.

In particular, a desired media card of a media card list or a desired content item of a media card can be selected such that a user can conveniently receives desired content from a content server.

A media apparatus can receive content from a content server and reproduce and output the content. Accordingly, a user can easily view desired content.

If a valid duration of a media card list has expired or the number of times that content can be reproduced has been exceeded, the media card or the content item of the media card is not displayed or is displayed in an inactivated state, such that a user conveniently checks available media cards or available content items of the media card.

The content server receives a content transmission request signal or media card information from the media apparatus, determines whether content can be transmitted, and transmits a message that the content is not available to the media apparatus, if the content cannot be transmitted. Accordingly, the media apparatus can easily manage the media cards of the media card list or the content items of the media card.

If the content can be transmitted, the content is transmitted to the media apparatus. Accordingly, it is possible to conveniently transmit content desired by a user to a desired media apparatus.

The content server receives, stores and manages information regarding the media card, the information regarding the media apparatus, etc., determines whether content can be provided by media cards or media apparatuses, and transmits the content to the media apparatus if the content can be provided. Accordingly, it is possible to transmit content desired by a user to a desired media apparatus.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a media system including a media card and a media apparatus according to an embodiment of the present invention;

FIG. 2 is a block diagram of a media reproduction apparatus of FIG. 1;

FIG. 3 is a block diagram showing the internal configuration of a controller of FIG. 2;

FIG. 4 is a view referred to for explaining a communication method between the media card and the media reproduction apparatus of FIG. 1;

FIG. 5 is a diagram showing a card information format of a media card;

FIG. 6 is a diagram showing information in a content information field of the card information format of FIG. 5;

FIG. 7 is a diagram showing information in a descriptor field of the card information format of FIG. 5;

FIG. 8 is a diagram showing a media system including a media card and a media apparatus according to another embodiment of the present invention;

FIG. 9 is a diagram showing a media system including a media card and a media apparatus according to another embodiment of the present invention;

FIG. 10 is a block diagram showing the internal configuration of an image display apparatus of FIG. 9;

FIG. 11 is a diagram showing a media system including a media card and a media apparatus according to another embodiment of the present invention;

FIG. 12 is a block diagram showing the internal configuration of a mobile terminal of FIG. 11;

FIG. 13 is a diagram showing a media system including a media card and a media apparatus according to another embodiment of the present invention;

FIG. 14 is a diagram showing a media system including a media card and a media apparatus according to another embodiment of the present invention;

FIG. 15 is a flowchart illustrating a method for operating a media apparatus according to an embodiment of the present invention;

FIGS. 16 to 21B are views referred to for describing various examples of the operating method of FIG. 15;

FIG. 22 is a flowchart illustrating a method for operating a content server according to an embodiment of the present invention; and

FIG. 23 is a block diagram showing the internal configuration of the content server of FIG. 1.

### DETAILED DESCRIPTION OF THE PREFERRED EMBODIMENTS

Exemplary embodiments of the present invention will be described with reference to the attached drawings.

The terms “module” and “unit” used to describe the names of components are used herein to aid the understanding of the components and thus they should not be considered as having specific meanings or roles. Accordingly, the terms “module” and “unit” may be used interchangeably.

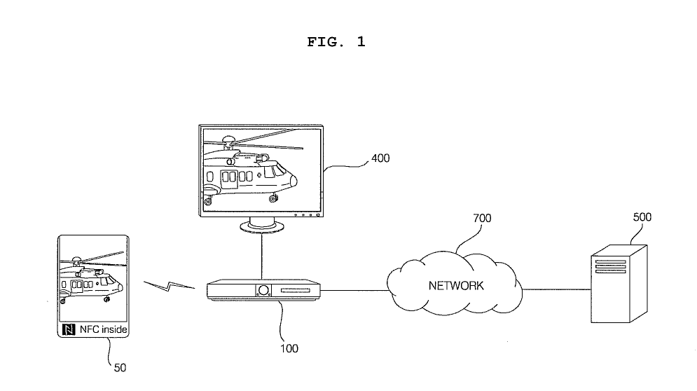

FIG. 1 is a diagram showing a media system including a media card and a media apparatus according to an embodiment of the present invention.

Referring to FIG. 1, the media system according to the embodiment of the present invention may include a media card 50, a media apparatus 100 or 400 and a content server 500.

The media card 50 may transmit data to the media apparatus 100 or 400 via short-range communication. In particular, the media card 50 may transmit data to the media apparatus 100 or 400 using a near field communication (NFC) method.

For example, if the media card 50 approaches the media reproduction apparatus 100 within a predetermined distance, that is, if the media card 50 is tagged, the media reproduction apparatus 100 may provide a magnetic field to the media card 50. The magnetic field is changed by the media card 50 and thus data of the media card 50 is transmitted to the media reproduction apparatus 100. Therefore, the media card 50 and the media reproduction apparatus 100 may perform NFC.

Such an NFC method refers to non-contact short-range wireless communication technology using a frequency band of 13.56 MHz and provides compatibility with conventional non-contact smart card technology and radio frequency identification (RFID) technology.

In order to perform the NFC method, the media apparatus 100 or 400 according to the embodiment of the present invention includes an NFC module. The NFC module will be described in detail below with reference to FIG. 4.

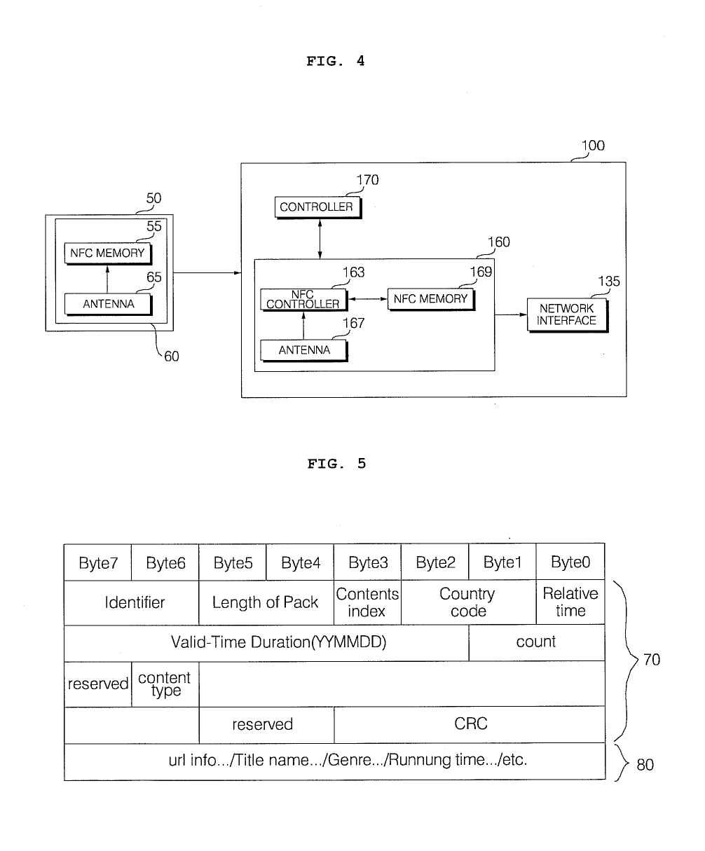

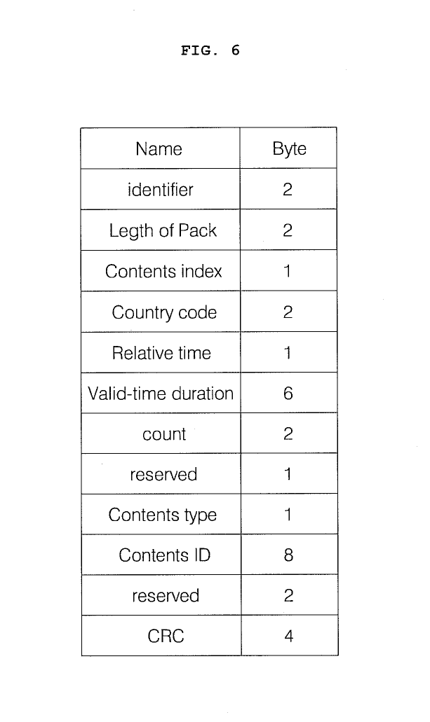

Meanwhile, the media card 50 according to the embodiment of the present invention may be a storage medium capable of performing NFC and may include content such as moving images, music, photos, books and games. More specifically, the media card may include content server information, content server address information, etc. The data format of the media card 50 will be described below with reference to FIGS. 5 to 7.

When a user purchases a media card 50 including information regarding desired content and tags the media card 50 to the media apparatus 100 or 400 capable of performing NFC, the media apparatus 100 or 400 may access a content server 500 over a network 700 using the content information stored in the media card and more specifically content server address information.

The media apparatus 100 or 400 may receive content from the content server 500 and reproduce and output the content. Then, the user can conveniently view desired content. That is, the user can conveniently view desired content by the operation of tagging the media card 50.

The media apparatus according to the embodiment of the present invention is an apparatus capable of processing media data and includes a media reproduction apparatus, an image display apparatus, a mobile terminal, etc.

The media reproduction apparatus may include not only an optical disc reproduction apparatus such as a DVD player or a Blu-ray player but also a memory reproduction apparatus such as a flash memory. The image display apparatus may include a TV receiver capable of displaying a broadcast, a monitor, a computer, etc. The mobile terminal is a mobile apparatus and may include a mobile phone, a smart phone, a laptop, a tablet PC, a digital camera, a camcorder, a mobile photo printer, etc.

In FIG. 1, an optical disc reproduction apparatus is shown as the media reproduction apparatus 100 and a TV receiver capable of displaying a broadcast is shown as the image display apparatus 400.

The media reproduction apparatus 100 accesses the content server 500 over the network 700 using the received content server information or content server address information by the tagging operation of the media card 50, receives content from the content server 500, and reproduces the content. If the reproduced content is an image, the content is reproduced by the media reproduction apparatus 100 and displayed on the image display apparatus 400. If the reproduced content is audio, the content is reproduced and output by the media reproduction apparatus 100.

Meanwhile, the media card 50 according to the embodiment of the present invention may perform NFC and thus may be referred to as an NFC card.

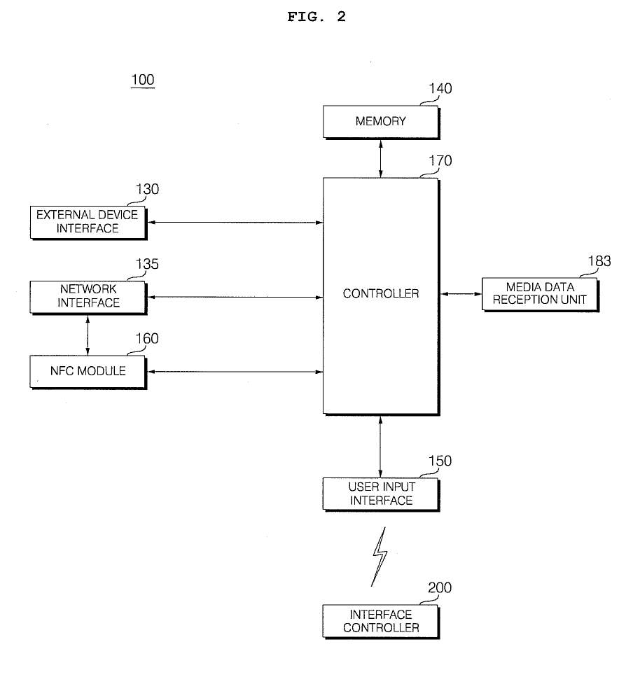

FIG. 2 is a block diagram of the media reproduction apparatus of FIG. 1.

Referring to FIG. 2, the media reproduction apparatus 100 according to an embodiment of the present invention may include a media data reception unit 183, an external device interface 130, a network interface 135, a memory 140, a user input interface 150, an NFC module 160 and a controller 170.

The media data reception unit 183 may receive data from a medium inserted into the media reproduction apparatus 100.

For example, if the media reproduction apparatus 100 is an optical disc reproduction apparatus for operating an optical disc, the media data reception unit 183 may rotate the optical disc and read media data from the optical disc.

As another example, if the media reproduction apparatus 100 includes a memory such as a flash memory, the media data reception unit 183 may read media data from the memory.

The external device interface 130 may transmit or receive data to or from the image display apparatus 400 connected by wire or wirelessly. For interfacing, the external device interface 130 may include an A/V Input/Output (I/O) unit (not shown).

The network interface 135 serves as an interface between the media reproduction apparatus 100 and a wired/wireless network such as the Internet. For example, the network interface 135 may access the content server 500 over the network 700 and receive content or data from the content server 500. The network interface 135 may transmit or receive data to or from the image display apparatus 400 connected by wire or wirelessly over the network.

The memory 140 may store various programs necessary for the controller 170 to process and control signals, and may also store processed video, audio and data signals.

The user input interface 150 transmits a signal input by the user to the controller 170 or transmits a signal received from the controller 170 to the user.

For example, the user input interface 150 may transmit or receive various user input signals such as a power-on/off signal, a channel selection signal, and a screen setting signal to or from a remote controller 200, transmit a user input signal input by a local key (not shown) such as a power key, a channel key, a volume key and a setting key to the controller 170, transmit a user input signal received by a sensor unit (not shown) for sensing a user gesture to the controller 170, or transmit a signal from the controller 170 to the sensor unit (not shown).

The controller 170 may process data received via the media data reception unit 183, the external device interface 130 or the network interface 135 and generate and output a video or audio signal.

A video and audio signal processed by the controller 170 may be input to the image display apparatus 400 via the external interface 130 or the network interface 135.

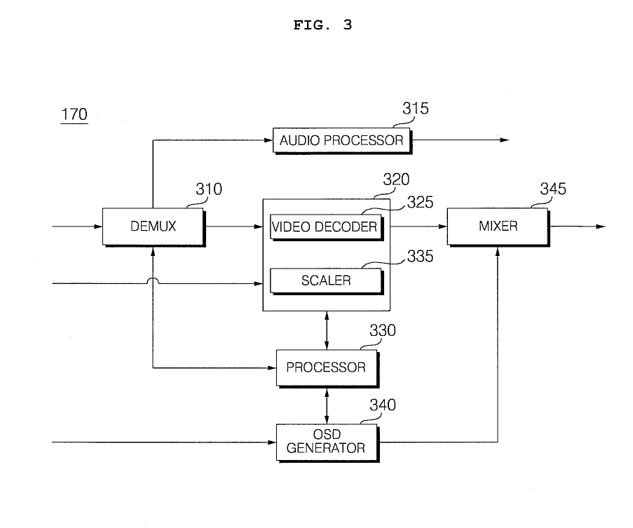

Although not shown in FIG. 2, the controller 170 may include a demultiplexer (DEMUX), a video processor, etc., which will be described below with reference to FIG. 3.

The controller 170 may control the overall operation of the media reproduction apparatus 100.

FIG. 3 is a block diagram showing the internal configuration of the controller of FIG. 2.

Referring to FIG. 3, the controller 170 according to the embodiment of the present invention may include a DEMUX 310, an audio processor 315, a video processor 320, a processor 330, an OSD generator 340, and a mixer 345. The controller 170 may further include a data processor (not shown).

The DEMUX 310 demultiplexes an input stream. For example, the DEMUX 310 may demultiplex an MPEG-2 TS into a video signal, an audio signal, and a data signal. The DEMUX 310 may receive a stream signal from the media data reception unit 183, the external device interface 130 or the network interface 135.

The audio processor 315 may process the demultiplexed audio signal. For audio processing, the audio processor 315 may include various decoders.

The audio processor 315 may control bass, treble, and volume of the audio signal.

The video processor 320 may process the demultiplexed video signal. For video signal processing, the video processor 320 may include a video decoder 325 and a scaler 335.

The video decoder 325 decodes the demultiplexed video signal and the scaler 335 scales the decoded video signal so that the video signal can be displayed on the image display apparatus 400.

The video decoder 325 may be provided with decoders that operate based on various standards.

The processor 330 may control the overall operation of the media reproduction apparatus 100 or the controller 170. For example, the processor 330 may control the media reproduction apparatus 100 according to a user command input through the user input interface (not shown) or an internal program.

The processor 330 may control transmission or reception of data to or from the network interface 135 or the external device interface 130.

The processor 330 may control the operations of the DEMUX 310, the video processor 320 and the OSD generator 340 of the controller 170.

The OSD generator 340 generates an OSD signal autonomously or according to user input. For example, the OSD generator 340 may generate signals by which a variety of information is displayed as graphics or text on the display 180, according to user input signals. The OSD signal may include various data such as a User Interface (UI), a variety of menus, widgets, icons, etc.

The mixer 345 may mix the decoded video signal processed by the video processor 320 with the OSD signal generated by the OSD generator 340.

The data processor (not shown) of the controller 170 may process the demultiplexed data signal. For example, if the demultiplexed data signal was encoded, the data processor may decode the data signal.

The block diagram of the controller 170 shown in FIG. 3 is exemplary. Depending upon the specifications of the image display apparatus 100 in actual implementation, the components of the block diagram may be integrated or omitted, or a new component may be added.

FIG. 4 is a view referred to for explaining a communication method between the media card and the media reproduction apparatus of FIG. 1.

Referring to FIG. 4, if the media card 50 approaches the media reproduction apparatus 100 within the predetermined distance, NFC may be initiated.

That is, the mobile terminal 600 and the media card 500 may transmit or receive data using an NFC method.

As shown in FIG. 4, the media card 50 may include an NFC module 60 including an NFC memory 55 and an antenna 65. The media reproduction apparatus 100 may include an NFC module 160 including an NFC controller 163 and an antenna 167.

The NFC memory 55 may include content information, such as content type information, content ID information and content server information or content server address information. The NFC memory 55 may be, for example, an EEPROM. The NFC memory 55 may be readable, but may not be writable.

The NFC module 60 is a passive tag and may be attached to a surface of the media card 50.

For example, if the user brings the media card 50 close to the media reproduction apparatus 100 within a predetermined distance, a magnetic field is provided. According to change in magnetic field, the media reproduction apparatus 100 may receive content information from the media card 50.

That is, information exchange or data exchange between the media card 50 and the media reproduction apparatus 100 may be performed based on a reader/writer mode of NFC. In particular, the media reproduction apparatus 100 may operate in a reader mode of NFC.

The antenna 167 of the media reproduction apparatus 100 receives content information from the media card 50. The received content information may be transmitted to the controller 170 of the media reproduction apparatus 100 via the NFC controller 163.

The controller 170 of the media reproduction apparatus 100 may control the network interface 130 to access the content server 500 using content information such as content server information or content server address information.

The network interface 130 may transmit a content data transmission request signal to the content server 500. At this time, the network interface 130 may also transmit information regarding the media reproduction apparatus 100. The network interface 130 may receive content from the content server 500.

Alternatively, the NFC controller 163 may control the network interface 130 to access the content server 500 using content information such as content server information or content server address information.

NFC is advantageous in that a communication start procedure is simple, but is disadvantageous in that it is difficult to transmit a large amount of data.

In the embodiment of the present invention, the media card 50 stores content information of about 64 bytes to 96 bytes and the media apparatus automatically accesses the content server using an NFC method and receives content.

The data format of the media card 50 will be described with reference to FIGS. 5 to 7.

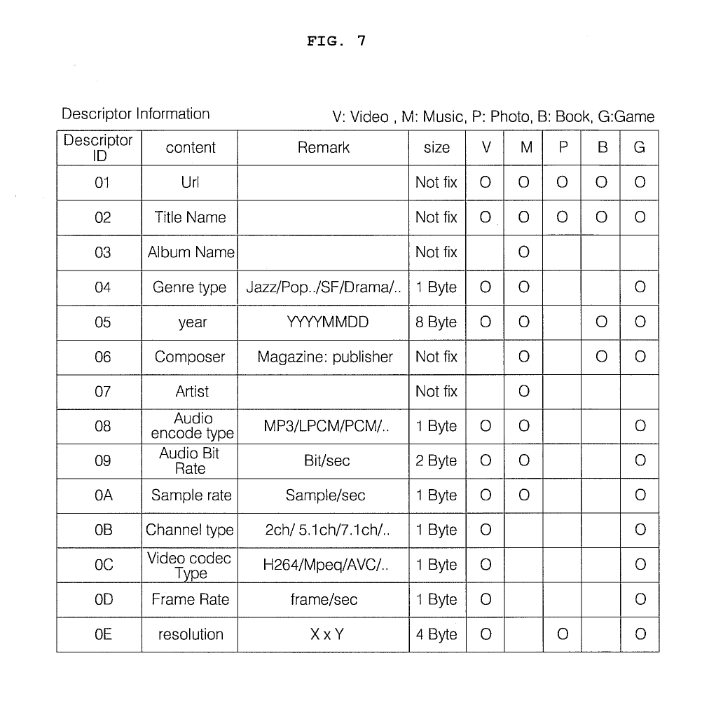

FIG. 5 is a diagram showing a card information format of a media card, FIG. 6 is a diagram showing information in a content information field of the card information format of FIG. 5, and FIG. 7 is a diagram showing information in a descriptor field of the card information format of FIG. 5.

First, referring FIG. 5, the media card 50 according to the embodiment of the present invention may include a content information field 70 including content type information, content ID information, etc. and a descriptor field 80 including content server information (url information), content server address information (final url information), etc.

The content information field 70 may have a size of 32 bytes and the descriptor field 80 may have a size of about 32 bytes to 64 bytes. The size of the content information may be about 64 bytes to 96 bytes.

Hereinafter, information in the content information field 70 will be described with reference to FIG. 6.

Fist, “Identifier” has a size of 2 bytes and may indicate ID information of a manufacturer of payload (e.g., LG) or ID information of a manufacture group compatible with the manufacturer. As another example, “Identifier” may indicate card information (e.g., a serial number of a media card, etc.) of the media card 50.

“Length of Pack” has a size of 2 bytes and may indicate a total byte number of payload of information of the content information field and information of the descriptor field, which is used in one packet.

“Contents index” has a size of 1 byte and indicates content index information of a media card. An index value starts from “1” and may be increased on a per content information basis. If the media card 50 includes a plurality of pieces of content information, index information may be provided to the content information. For example, “1” may indicate index information of audio content and “2” may indicate index information of e-book content.

“Country code” has a size of 2 bytes and may indicate information indicating a country for releasing the media card 50, information indicating a country for using the media card 50, or information indicating a country of the accessible content server 500.

“Relative time” has a size of 1 byte and may indicate whether a subsequent “valid-time duration” is a relative time or an absolute time. For example, “Relative time” having a value of “1” may indicate that “Valid-time duration” is a relative time and “Relative time” having a value of “0” may indicate that “Valid-time duration” is an absolute time.

“Valid-time duration” has a size of 6 bytes and may indicate valid duration information of the media card or valid duration information of content download. The valid duration may be represented in the form of year/month/day YYMMDD.

If “Relative time” has a value of “1”, YYMMDD of “Valid-time duration” may indicate the valid duration of the media card indicating how long the media card can be used.

If “Relative time” has a value of “0”, YYMMDD of “Valid-time duration” may indicate the valid duration of the media card indicating an expiration date of the media card.

“count” has a size of 2 bytes and may indicate information regarding the number of times that content can be reproduced via the media card, information regarding the number of times that content can be downloaded from the content server, and information regarding the number of times that content can be viewed.

“reserved” has a size of 1 byte and may be used for other settings.

“Contents type” has a size of 1 byte and may indicate content type information. For example, “Contents type” having a value of “1” may indicate video, “Contents type” having a value of “2” may indicate audio, “Contents type” having a value of “3” may indicate music, “Contents type” having a value of “4” may indicate book, and “Contents type” having a value of “5” may indicate game. “Contents type” having a value of “0” may indicate a content type other than the above-described content types.

“Contents ID” has a size of 8 bytes and may include ID information of reproducible content. Meanwhile, “Contents ID” may further include content server information (URL information) or content server address information (final URL information). Alternatively, “Contents ID” may include only actual content ID information except for URL information or final URL information.

“reserved” has a size of 2 bytes and may be used for other settings.

“CRC” has a size of 4 bytes and is attached for error check.

The description field 80 may have a size of 8 bytes to 24 bytes.

Next, referring to FIG. 7, in information of the descriptor field 80, “URL” having a descriptor ID of “01” may indicate content server information (URL information) or content server address information (final URL information) of content such as video, music, a photo, an e-book and a game.

“Title Name” having a descriptor ID of “02” may indicate a content title name of content such as video, music, a photo, an e-book and a game.

“Album Name” having a descriptor ID of “03” may indicate an album name of content such as music.

“Genre type” having a descriptor ID of “04” has a size of 1 byte and may indicate the genre of content. For example, “Genre type” may indicate the genre of music content, such as jazz or pop. As another example, “Genre type” may indicate the genre of video content, such as SF or drama.

“year” having a descriptor ID of “05” has a size of 8 bytes and may indicate a content release date.

“Composer” having a descriptor ID of “06” may indicate information regarding a composer, a lyricist and an arranger of music content.

“Artist” having a descriptor ID of “07” may include information regarding an artist of music content.

“Audio encode type” having a descriptor ID of “08” has a size of 1 byte and may indicate an audio encode type of video, music or game content. For example, “Audio encode type” may indicate an encoding method such as MP3, LPCM or PCM.

“Audio Bit Rate” having a descriptor ID of “09” has a size of 2 bytes and may indicate an audio bit rate of video, music or game content.

“Sample rate” having a descriptor ID of “0A” has a size of 1 byte and may indicate a sample rate of video, music or game content.

“Channel type” having a descriptor ID of “0B” has a size of 1 byte and may indicate audio channel information of video, music or game content. For example, “Channel type” may indicate audio channel information such as 2ch, 5.1ch or 7.1ch.

“Video codec type” having a descriptor ID of “0C” has a size of 1 byte and may indicate a video codec type of video or game content. “Video codec type” may indicate a video coding method such as H264, MPEG or AVC.

“Frame Rate” having a descriptor ID of “0D” has a size of 1 byte and may indicate a frame rate of video or game content.

“resolution” having a descriptor ID of “0E” has a size of 4 bytes and may indicate resolution of an image of video or game content.

Hereinafter, a procedure of processing content related information of the media card 50 in the media apparatus 100 or 400 and the content server 500 will be described.

If the media card 50 and the media apparatus 100 or 400 perform NFC, the media apparatus 100 or 400 receives content related information (content information or descriptor information) described with reference to FIGS. 5 to 7.

The media apparatus 100 or 400 extracts content ID information and content type information from content information received by the NFC module.

Next, the media apparatus 100 or 400 retrieves unique media card service URL information (content server information) provided to the media apparatus 100 or 400.

The media apparatus 100 or 400 generates final URL information (content server address information) using the content ID information, the content type information and the unique media card service URL information (content server information). The final URL information (content server address information) may be an address of the content server from which content may be downloaded.

For example, the content ID information and the content type information are as follows.

The content ID of first content in the media card may be “0x0000000000000001” and the content type thereof may be “0x01”. The content ID of second content in the media card may be “0x0000000000000002” and the content type thereof may be “0x02”. The content ID of third content in the media card may be “0x0000000000000003” and the content type thereof may be “0x02”. The content ID of fourth content in the media card may be “0x0000000000000004” and the content type may be “0x04”.

The unique media card service URL provided to the media apparatus 100 or 400 may be “http://www.mediacard.com/lge”.

The final URL may be set to “http://www.mediacard.com/lge?t=01&i=0000000000000001&t=02&i=0000000000000002&t=02&i=0000000000000003&t=04&i=00000000000 00004”.

From the final URL, it can be seen that the unique media card service URL, the content type and the content ID are arranged in this order.

Meanwhile, unlike the above description, the final URL may be set using “URL” in the descriptor field. At this time, the unique media card service URL provided to the media apparatus 100 or 400 is not considered. It is assumed that “URL” in the descriptor field is not final URL information (content server address information), but is URL information (content server information).

That is, if “URL” in the descriptor field is “http://www.mediacard.com/xognsdl”, the final URL calculated using the content ID information, the content type information and “URL” may be set to “http://www.mediacard.com/xognsdl?t=01&i=0000000000000001&t=02&i=0000000000000002&t=02&i=0000000000000003&t=04&i=0000000 000000004”.

Unlike the above description, the content server address information (final URL information) may be set using the content server information (URL information) included in “content ID”.

That is, if it is assumed that the content server information (URL information) included in “content ID” is “http://www.mediacard.com/xognsdl”, the final URL calculated using the content type information and the content ID information of “content ID” may be set to “http://www.mediacard.com/xognsdl?t=01&i=0000000000000001&t=02&i=0000000000000002&t=02&i=0000000000000003&t=04&i=0000000 000000004”.

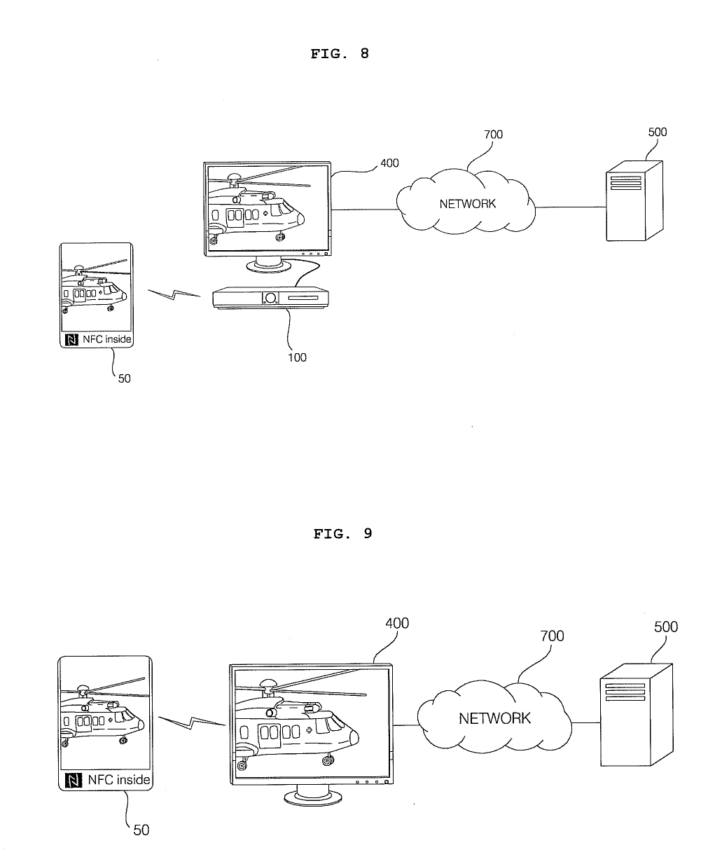

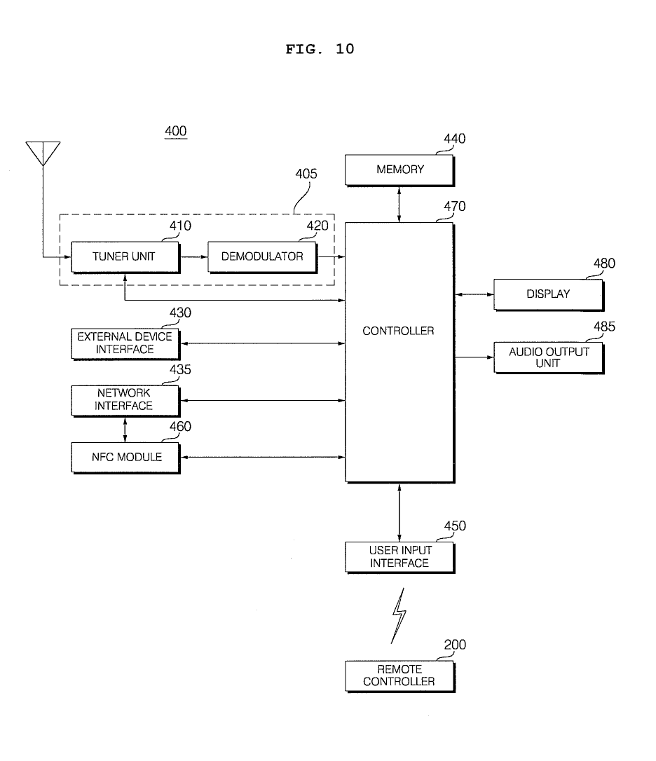

FIG. 8 is a diagram showing a media system including a media card and a media apparatus according to another embodiment of the present invention.

Referring to FIG. 8, the media system according to the embodiment of the present invention may include a media card 50, a media apparatus 100 or 400 and a content server 500.

The media system of FIG. 8 is similar to the media system of FIG. 1, except that NFC is performed between the media card 50 and the media reproduction apparatus 100 and the image display apparatus 400 and the content server 500 transmit or receive data over the network 700.

That is, if the media card 50 approaches the media reproduction apparatus 100 within a predetermined distance, that is, if the media card 50 is tagged, the media reproduction apparatus 100 receives content related information stored in the media card 50 and extracts content server address information therefrom and transmits the content server address information to the image display apparatus 400.

The image display apparatus 400 may access the content server 500 over the network 700 using the content server information or the content server address information received from the media reproduction apparatus 100.

The image display apparatus 400 may receive content from the content server 500 and reproduce and output the content. Then, the user can conveniently view desired content.

The image display apparatus 400 may receive content related information stored in the media card 50 from the media reproduction apparatus 100 and extract content server address information therefrom.

FIG. 9 is a diagram showing a media system including a media card and a media apparatus according to another embodiment of the present invention.

Referring to FIG. 9, the media system according to the embodiment of the present invention may include a media card 50, a media apparatus 400 and a content server 500.

The media system of FIG. 9 is similar to the media system of FIG. 8, except that NFC is performed between the media card 50 and the image display apparatus 400 and the image display apparatus 400 and the content server 500 transmit or receive data over the network 700.

That is, if the media card 50 approaches the image display apparatus 400 within a predetermined distance, that is, if the media card 50 is tagged, the image display apparatus 400 receives content related information stored in the media card 50 and extracts content server address information therefrom.

The image display apparatus 400 may access the content server 500 over the network 700 using the content server address information received from the media card 50.

The image display apparatus 400 may receive content from the content server 500 and reproduce and output the content. Then, the user can conveniently view desired content.

FIG. 10 is a block diagram showing the internal configuration of the image display apparatus of FIG. 9.

Referring to FIG. 10, the image display apparatus 400 which is a media apparatus according to an embodiment of the present invention may include a broadcast reception unit 405, an external device interface 430, a network interface 435, a memory 440, a user input interface 450, an NFC module 460, a controller 470, a display 480 and an audio output unit 485.

The external device interface 430, the network interface 435, the memory 440, the user input interface 450, the NFC module 460 and the controller 470 of FIG. 10 are respectively identical to the external interface 130, the network interface 135, the memory 140, the user input interface 150, the NFC module 160 and the controller of the media reproduction apparatus 100 shown in FIG. 2 and thus a description thereof will be omitted. Hereinafter, a difference between FIG. 2 and FIG. 10 will be focused upon.

The broadcast reception unit 405 may include a tuner unit 410 and a demodulator 420. As needed, the broadcast reception unit 405 may include the network interface 430 in addition to the tuner unit 410 and the demodulator 420.

The tuner unit 410 tunes to a Radio Frequency (RF) broadcast signal corresponding to a channel selected by a user from among RF broadcast signals received through an antenna or RF broadcast signals corresponding to all channels previously stored in the image display apparatus. The tuned RF broadcast is converted into an Intermediate Frequency (IF) signal or a baseband Audio/Video (AV) signal.

For example, the tuned RF broadcast signal is converted into a digital IF signal DIF if it is a digital broadcast signal and is converted into an analog baseband AV signal (Composite Video Banking Sync/Sound Intermediate Frequency (CVBS/SIF)) if it is an analog broadcast signal. That is, the tuner unit 410 may process a digital broadcast signal or an analog broadcast signal. The analog baseband AV signal (CVBS/SIF) output from the tuner unit 410 may be directly input to the controller 470.

The tuner unit 410 may be capable of receiving RF broadcast signals from an Advanced Television Systems Committee (ATSC) single-carrier system or from a Digital Video Broadcasting (DVB) multi-carrier system.

The tuner unit 410 may sequentially tune to RF broadcast signals corresponding to all broadcast channels stored through a channel storage function among RF broadcast signals received through an antenna and may convert the tuned RF broadcast signals into IF signals or baseband A/V signals.

The tuner unit 410 may include a plurality of tuners in order to receive broadcast signals of a plurality of channels or a single tuner for simultaneously receiving broadcast signals of a plurality of channels.

The demodulator 420 receives and demodulates the digital IF signal DIF converted by the tuner 410.

The demodulator 420 may perform demodulation and channel decoding and output a stream signal TS. The stream signal TS may be a signal in which a video signal, an audio signal and a data signal are multiplexed.

The stream signal output from the demodulator 420 may be input to the controller 470. The controller 470 performs demultiplexing and A/V signal processing with respect to the stream signal. The processed video and audio signals are output to the display 480 and the audio output unit 485, respectively.

The display 480 converts the video signal, the data signal, the OSD signal and the control signal processed by the controller 470 or the video signal, the data signal and the control signal received by the external device interface 430 and generates a drive signal.

The display 480 may be a Plasma Display Panel (PDP), a Liquid Crystal Display (LCD), an Organic Light-Emitting Diode (OLED) display or a flexible display. In particular, the display 480 may be a 3D display.

If the display 480 is a touchscreen display, the display 480 may function as not only an output device but also as an input device.

The audio output unit 485 receives the audio signal processed by the controller 470 and outputs the received audio signal as sound.

A camera unit (not shown) captures images of a user. The camera unit (not shown) may be implemented by one camera. However, the present invention is not limited thereto and the camera unit may be implemented by a plurality of cameras. The camera unit (not shown) may be provided on the display 480 of the image display apparatus 400 or may be separately provided. Image information captured by the camera unit (not shown) may be input to the controller 470.

The controller 470 may sense a user gesture based on an image captured by the camera unit (not shown), a signal sensed by a sensor unit (not shown) or a combination thereof.

The remote controller 200 transmits user input to the user input interface 450.

The above-described image display apparatus 400 may be a fixed or mobile digital broadcast receiver.

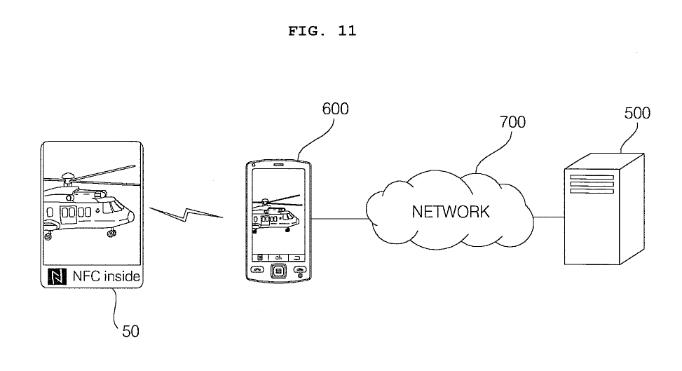

FIG. 11 is a diagram showing a media system including a media card and a media apparatus according to another embodiment of the present invention.

Referring to FIG. 11, the media system according to the embodiment of the present invention may include a media card 50, a media apparatus 600 and a content server 500.

The media system of FIG. 11 is similar to the media system of FIG. 8, except that NFC is performed between the media card 50 and the mobile terminal 600 and the mobile terminal 600 and the content server 500 transmit or receive data over the network 700.

That is, if the media card 50 approaches the mobile terminal 600 within a predetermined distance, that is, if the media card 50 is tagged, the mobile terminal 600 receives content related information stored in the media card 50 and extracts content server address information therefrom.

The mobile terminal 600 may access the content server 500 over the network 700 using the content server address information received from the media card 50.

The mobile terminal 600 may receive content from the content server 500 and reproduce and output the content. Then, the user can conveniently view desired content.

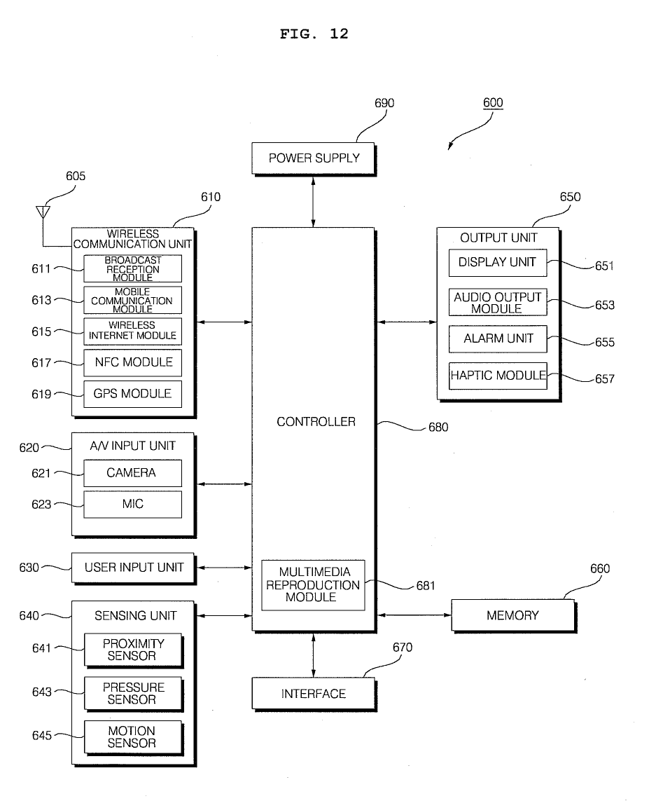

FIG. 12 is a block diagram showing the internal configuration of the mobile terminal of FIG. 11.

Referring to FIG. 12, the mobile terminal 600 may include a wireless communication unit 610, an audio/video (A/V) input unit 620, a user input unit 630, a sensing unit 640, an output unit 650, a memory unit 660, an interface unit 670, a controller 680 and a power supply 690.

The wireless communication unit 610 may include a broadcast reception module 611, a mobile communication module 613, a wireless Internet module 615, an NFC module 617, and a global positioning system (GPS) module 619.

The broadcast reception module 611 receives at least one of a broadcast signal and broadcast-related information from an external broadcast management server through a broadcast channel. The broadcast channel may include a satellite channel and a terrestrial channel.

The broadcast signal and/or the broadcast-related information received through the broadcast reception module 611 may be stored in the memory 660.

The mobile communication module 613 transmits or receives a wireless signal to or from at least one of a base station, an external terminal and a server over a mobile communication network. The wireless signal may include a voice call signal, a video call signal or various types of data associated with transmission and reception of a text/multimedia message.

The wireless Internet module 615 is an internal or external module for wireless Internet access which may be provided to the mobile terminal 600.

The NFC module 617 may perform NFC. The NFC module 617 may receive content related information from the media card 50 if the media card 50 approaches the mobile terminal 600 within a predetermined distance, that is, if the media card 50 is tagged, which is described above with reference to FIG. 4.

As short-range wireless communication technology, Bluetooth, Radio-Frequency IDentification (RFID), Infrared Data Association (IrDA), Ultra WideBand (UWB), and ZigBee may be used.

The GPS module 619 may receive position information from a plurality of GPS satellites.

The A/V input unit 610 receives an audio signal or a video signal and may include a camera 621 and a microphone 623.

The user input unit 630 generates key input data enabling the user to control the operation of the terminal. The user input unit 630 may include a keypad, a dome switch, a touchpad (static pressure/static electrical), etc. In particular, if the touchpad and the display 651 have a layered structure, it may be called a touchscreen.

The sensing unit 640 detects a current state of the mobile terminal 600 such as whether the mobile terminal 600 is opened or closed, the position of the mobile terminal 600 and contact/non-contact of a user and generates a sensing signal for controlling the operation of the mobile terminal 600.

The sensing unit 640 may include a proximity sensor 641, a pressure sensor 643 and a motion sensor 645. The motion sensor 645 may sense motion or position of the mobile terminal 600 using an acceleration sensor, a gyroscopic sensor and a gravity sensor. In particular, the gyroscopic sensor measures an angular speed and senses a direction (angle) in which the mobile terminal rotates from a reference direction.

The output unit 650 may include a display 651, an audio output module 653, an alarm unit 655 and a haptic module 657.

The display 651 displays information processed by the mobile terminal 600.

As described above, if the display 651 and the touchpad have the layered structure to configure the touchscreen, the display 651 can be used not only as an output device but also as an input device for inputting information via user touch.

The audio output module 653 may output audio data received from the wireless communication module 610 or stored in the memory 660. The audio output module 653 may include a speaker, a buzzer, etc.

The alarm unit 655 outputs a signal notifying the user that an event has occurred in the mobile terminal 600. The alarm unit 253 outputs a signal notifying the user of the occurrence of an event in the form of vibrations.

The haptic module 657 generates a variety of tactile effects that the user can feel. A typical example of the tactile effect generated by the haptic module 657 is vibration.

The memory 660 may store a program for processing and control of the controller 680 and may temporarily store input or output data (for example, a phonebook, messages, audio, still images, and moving images).

The interface 670 serves as an interface with all external devices connected to the mobile terminal 600. The interface 670 may receive data from an external device or receive power and transmit power to the components of the mobile terminal 600 or transmit data of the mobile terminal 600 to an external device.

The controller 680 controls the overall operation of the mobile terminal 600. For example, the controller 680 performs control and processing associated with voice communication, data communication, video communication, and the like. The controller 680 may include a multimedia reproduction module 681 for multimedia reproduction. The multimedia reproduction module 681 may be implemented in the controller 680 in hardware form or may be implemented in software form separately from the controller 680.

The power supply 690 receives external power or internal power and supplies power required for operation to each component under control of the controller 680.

The mobile terminal 600 having the above configuration includes a wired/wireless communication system and a satellite based communication system so as to operate in a communication system for transmitting data through a frame or packet.

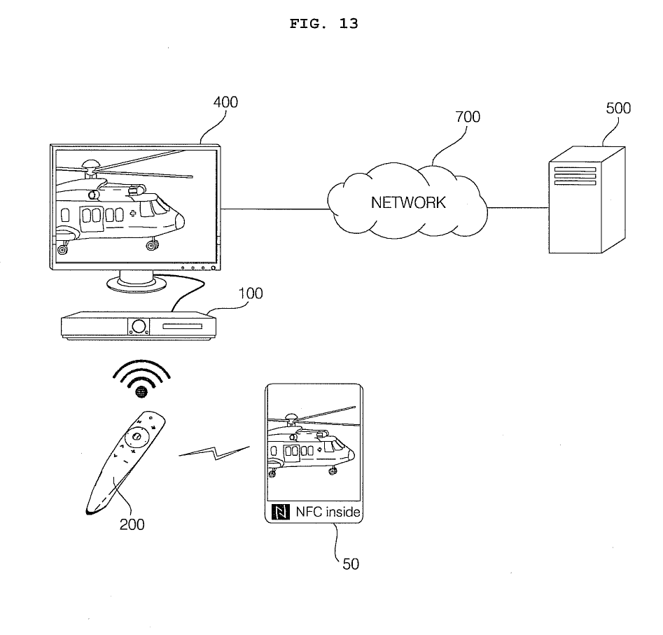

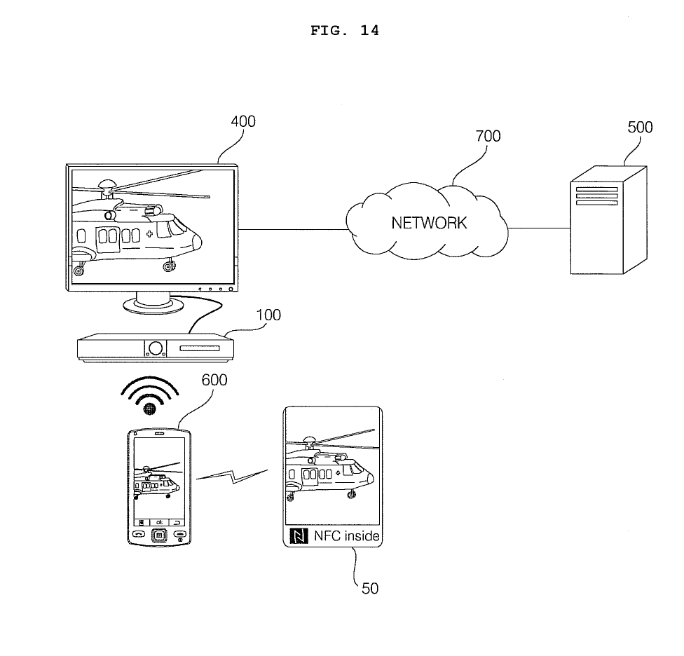

FIG. 13 is a diagram showing a media system including a media card and a media apparatus according to another embodiment of the present invention.

Referring to FIG. 13, the media system according to the embodiment of the present invention may include a media card 50, a media apparatus 100 or 400, a remote controller 200 and a content server 500.

The media system of FIG. 13 is similar to the media system of FIG. 1, except that NFC is performed between the media card 50 and the remote controller 200 and the image display apparatus 400 and the content server 500 transmit or receive data over the network 700.

That is, if the media card 50 approaches the remote controller 200 within a predetermined distance, that is, if the media card 50 is tagged, the remote controller 200 receives content related information stored in the media card 50. The remote controller 200 transmits the received content related information to the media reproduction apparatus 100 using an RF communication method, a ZigBee communication method, a Bluetooth communication method, etc.

The media reproduction apparatus 100 extracts the received content server address information and transmits the content server address information to the image display apparatus 400.

The image display apparatus 400 accesses the content server 500 over the network 700 using the content server address information received from the media reproduction apparatus 100.

The image display apparatus 400 may receive content from the content server 500 and reproduce and output the content. Then, the user can conveniently view desired content.

The image display apparatus 400 may receive all content related information stored in the media card 50 from the media reproduction apparatus 100 and extract content server address information therefrom.

FIG. 14 is a diagram showing a media system including a media card and a media apparatus according to another embodiment of the present invention.

Referring to FIG. 14, the media system according to the embodiment of the present invention may include a media card 50, a media apparatus 100, 400 or 600, and a content server 500.

The media system of FIG. 14 is similar to the media system of FIG. 13, except that the mobile terminal 600 is used instead of the remote controller 200, and thus a description thereof will be omitted.

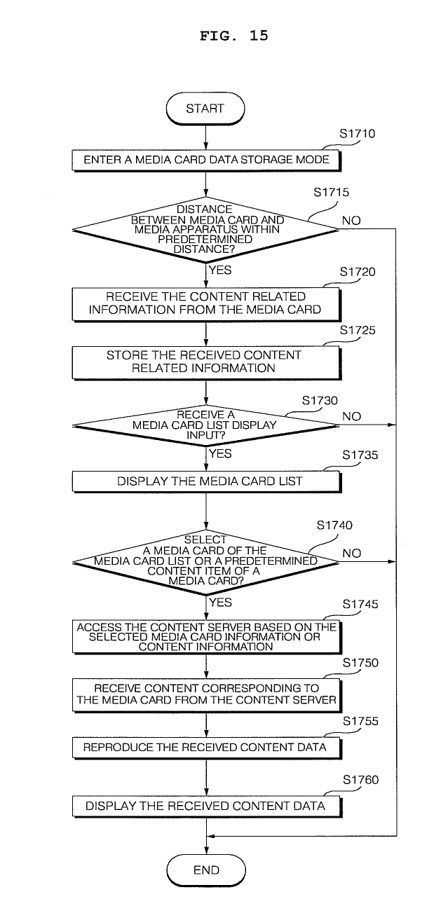

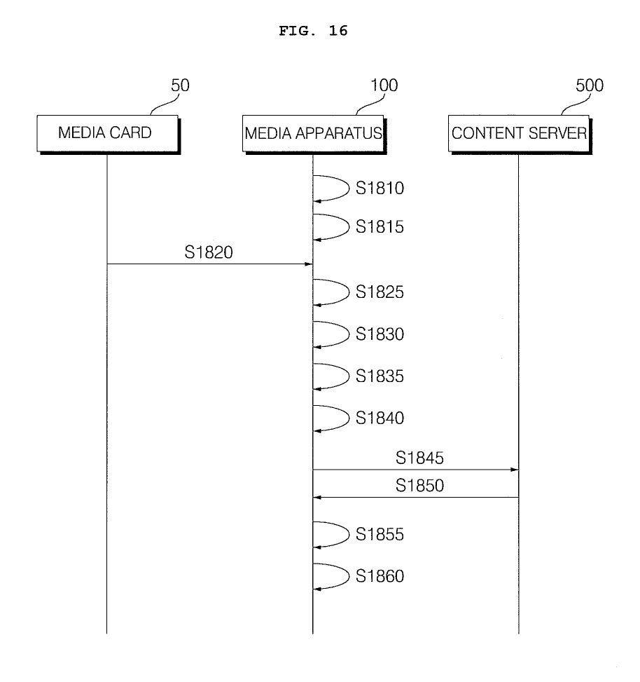

FIG. 15 is a flowchart illustrating a method for operating a media apparatus according to an embodiment of the present invention. FIGS. 16 to 21B are views referred to for describing various examples of the operating method of FIG. 15.

Referring to FIGS. 15 to 21B, the media reproduction apparatus 100 which is a media apparatus may enter a media card data storage mode (S1710). Meanwhile, step S1710 corresponds to step S1810 of FIG. 16.

For example, the media reproduction apparatus 100 may enter the media card data storage mode using a local key of the media reproduction apparatus 100 or a specific key of the remote controller. Alternatively, the media reproduction apparatus 100 may enter the media card data storage mode via a menu displayed on the display 480 of the image display apparatus 400, for example, a media card menu.

Next, if the media card 50 approaches the media reproduction apparatus 100 within a predetermined distance (S1715), that is, if the media card 50 is tagged, the media reproduction apparatus receives the content related information from the media card (S1720) and stores the received content related information (S1725). Step S1715 corresponds to step S1815 of FIG. 16, step S1720 corresponds to step S1820 of FIG. 16 and step S1725 corresponds to step S1825 of FIG. 16.

More specifically, the NFC module 160 of the media reproduction apparatus 100 receives content information and descriptor information as content related information shown in FIG. 5 through NFC.

The received content information and descriptor information are divided and stored by media cards. In particular, the received content information and descriptor information are stored in the memory 140 of the media reproduction apparatus 100. Alternatively, if the NFC module 160 includes a memory (not shown), the received content information and descriptor information may be stored in the NFC module. Hereinafter, it is assumed that the received content information and descriptor information are stored in the media apparatus, for example, in the memory 140 of the media reproduction apparatus 100.

The controller 170 may generate a media card list based on the stored content related information of the media card. Thus, the memory 140 of the media reproduction apparatus 100 may store the media card list.

If the media apparatus is an image display apparatus 400, the image display apparatus 400 may receive the content related information of the media card through the NFC module 460 and the controller 470 of the image display apparatus 400 may generate the media card list based on the content related information of the media card. Thus, the memory 440 of the image display apparatus 400 may store the media card list.

Next, if a media card list display input is received (S1730), the media card list is displayed (S1735).

For example, if the media card list display input is received using a local key of the media reproduction apparatus 100 or a specific key of the remote controller, the media reproduction apparatus 100 may enter a media card list display mode stored in the media reproduction apparatus. Alternatively, the media reproduction apparatus 100 may enter a media card list display mode through a menu displayed on the display 480 of the image display apparatus 400, for example, a media card menu.

As another example, if the media card 50 is tagged by the media apparatus 100 or 400, the media apparatus 100 or 400 may receive the content related information from the media card and automatically display the media card list. At this time, whenever the media card 50 is continuously tagged, the number of media card objects in the displayed media card list may be increased. A media card object corresponding to a recently tagged media card may be highlighted so as to be distinguished from other media card objects. Whenever the media card 50 is continuously tagged, the memory 440 may store information related to the media card by media cards.

The controller 170 of the media reproduction apparatus 100 may transmit the media card list to the image display apparatus 400 through the external device interface 130, if the media card list display input is received. Then, the image display apparatus 400 may receive the media card list through the external device interface 430 and display the media card list on the display 480.

If the media apparatus is an image display apparatus 400, the controller 470 of the image display apparatus 400 controls display of the media card list stored in the memory 440 on the display 480 according to the media card list display input.

The displayed media card list may include a plurality of media card objects if a plurality of media cards is tagged.

Next, if a media card of the media card list or a predetermined content item of a media card is selected (S1740), the media reproduction apparatus accesses the content server based on the selected media card information or content information (S1745). Step S1740 corresponds to step S1840 of FIG. 16 and step S1745 corresponds to step S1845.

If the media card of the media card list or the predetermined content item of the media card is selected, the media reproduction apparatus 100 extracts content server information based on at least one of content information or descriptor information of the selected media card or the predetermined content item of the media card.

For example, the NFC controller 163 of the NFC module 160 or the controller 170 of the media reproduction apparatus 100 extracts content ID information and content type information from the content information of the selected media card or the predetermined content item of the media card.

The NFC controller 163 of the NFC module 160 or the controller 170 of the media reproduction apparatus 100 retrieves unique media card service URL information (content server information) provided to the media reproduction apparatus 100. The unique URL information may be stored in the NFC controller 163 of the NFC module 160 or the memory 140.

The NFC controller 163 of the NFC module 160 or the controller 170 of the media reproduction apparatus 100 may generate final URL information (content server address information) using the content ID information, the content type information and the unique media card service URL information (content server information).

Except for the unique media card service URL information provided to the media reproduction apparatus 100, the final URL information (content server address information) may be set using “URL” of the descriptor information or “URL” of the “content ID”.

The NFC controller 163 of the NFC module 160 or the controller 170 of the media reproduction apparatus 100 may set the final URL information (content server address information using the content ID information, the content type information and content server information (URL information) included in the “content ID” of the selected media card or the predetermined content item of the media card.

The network interface 135 of the media reproduction apparatus 100 accesses the content server 500 over the network 700 based on the extracted final URL information, that is, the content server address information. That is, the network interface 130 may transmit a content data transmission request signal to the content server 500. At this time, information regarding the media reproduction apparatus 100 may also be transmitted.

The content server 500 may receive the content transmission request corresponding to the media card. If the information regarding the media reproduction apparatus is also received, the content server 500 may identify the media apparatus for requesting transmission of content corresponding to the media card. That is, if different media apparatuses request content transmission using the same media card, the content server may distinguish the media apparatuses from one another.

If the media apparatus is an image display apparatus 400, the controller 470 of the image display apparatus 400 calculates final URL information (content server address information) using the content ID information, the content type information, etc. of the selected media card or predetermined content item of the media card. The network interface 435 of the image display apparatus 400 accesses the content server 500 over the network 700 based on the extracted final URL information, that is, the content server address information. That is, the network interface 430 may transmit a content data transmission request signal to the content server 500. At this time, information regarding the image display apparatus 400 may also be transmitted.

Next, content corresponding to the media card is received from the content server (S1750). Step S1750 corresponds to step S1850 of FIG. 16.

The network interface 135 of the media reproduction apparatus 100 receives content of the selected media card or predetermined content item of the media card from the content server 500. The received content data may be received in the form of a stream.

If the media apparatus is an image display apparatus 400, the network interface 435 of the image display apparatus 400 receives content of the selected media card or predetermined content item of the media card from the content server 500.

Next, the received content data is reproduced (S1755). Step S1755 corresponds to step S1855 of FIG. 16.

The controller 170 of the media reproduction apparatus 100 processes the received content corresponding to the media card. For example, if the content data is received in the form of a stream, the DEMUX of the controller 170 demultiplexes the content data into a video signal, an audio signal and a data signal.

The video signal, the audio signal and the data signal are decoded by respective decoders and are subjected to signal processing such as scaling, image quality control or sound quality control, thereby reproducing the content.

If the media apparatus is an image display apparatus 400, the controller 470 of the image display apparatus 400 processes the received content corresponding to the media card.

Next, the reproduced content data is displayed (S1760). Step S1760 corresponds to step S1860 of FIG. 16.

The controller 170 of the media reproduction apparatus 100 controls transmission of the reproduced content, that is, the video signal and the audio signal, to the image display apparatus 400 through the external device interface 130.

The image display apparatus 400 may display video content, e-book content, etc. on the display 480 and output audio content through the audio output unit 485.

If the media apparatus is an image display apparatus 400, the content processed by the controller 470 of the image display apparatus 400 is output through the display 480 or the audio output unit 485.

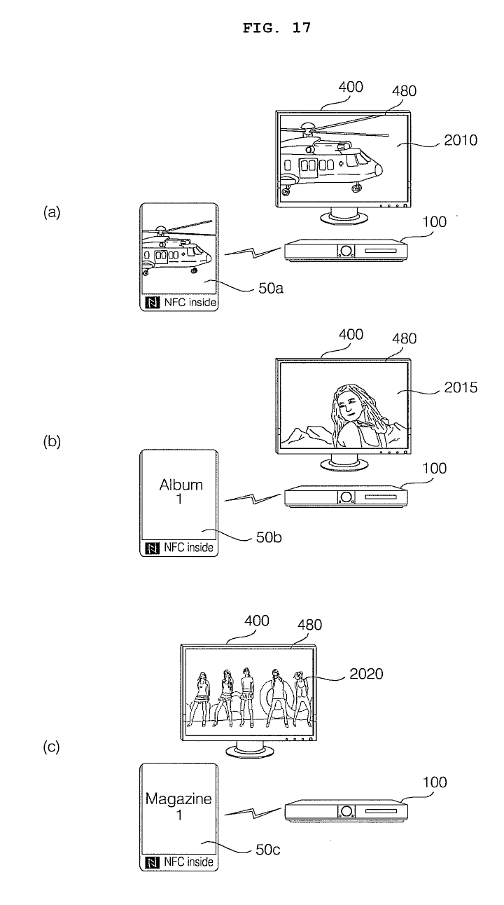

FIGS. 17 to 21B are views referred to for describing various examples of the operating method of FIG. 15.

First, in FIG. 17(a), if a movie related media card 50a approaches the media reproduction apparatus 100 within a predetermined distance, that is, if the movie related media card is tagged, the media reproduction apparatus 100 receives movie related content information via NFC, receives movie content corresponding thereto through the content server 500, and displays movie related content 2010 on the display 480 of the image display apparatus 400.

Next, in FIG. 17(b), if a music related media card 50b approaches the media reproduction apparatus 100 within a predetermined distance, that is, if the music related media card is tagged, the media reproduction apparatus 100 receives music related content information via NFC, receives music content corresponding thereto through the content server 500, and displays music related content 2015 on the display 480 of the image display apparatus 400.

Next, in FIG. 17(c), if a magazine related media card 50c approaches the media reproduction apparatus 100 within a predetermined distance, that is, if the magazine related media card is tagged, the media reproduction apparatus 100 receives magazine related content information via NFC, receives magazine content corresponding thereto through the content server 500, and displays magazine related content 2020 on the display 480 of the image display apparatus 400.

In the embodiment of the present invention, in order to view desired content, each media card is tagged by the media reproduction apparatus. In addition, for user convenience, a media card list including previously tagged media cards is stored in a memory and is displayed when a user wishes to view the media card list.

That is, if the media cards 50a, 50b and 50c of FIGS. 17(a), 17(b) and 17(c) are tagged, the media reproduction apparatus 100 generates and stores a media list thereof. If a media list display input is received, the media list is displayed on the display 480 of the image display apparatus 400.

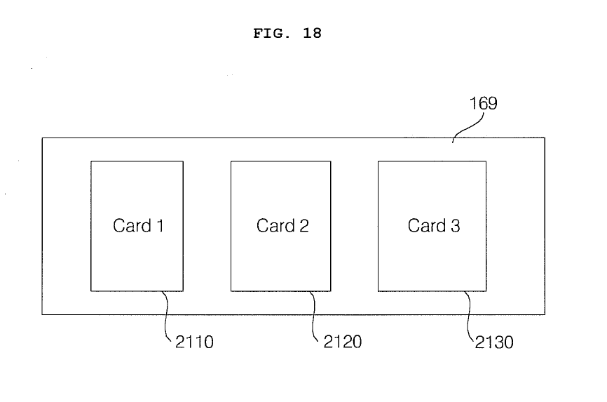

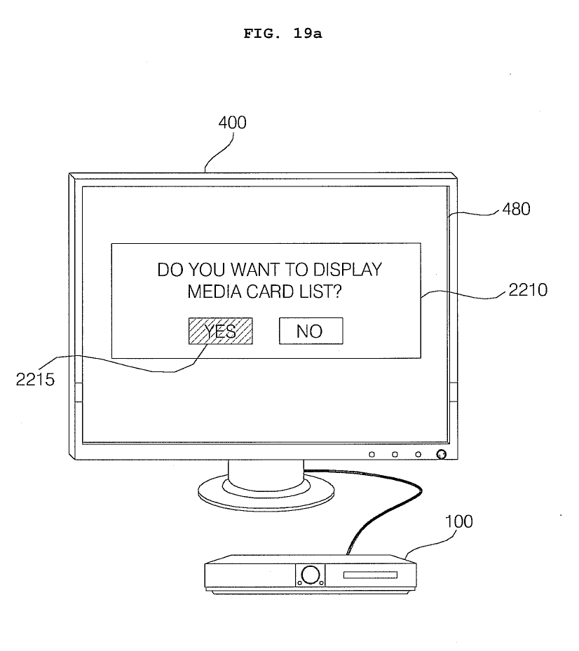

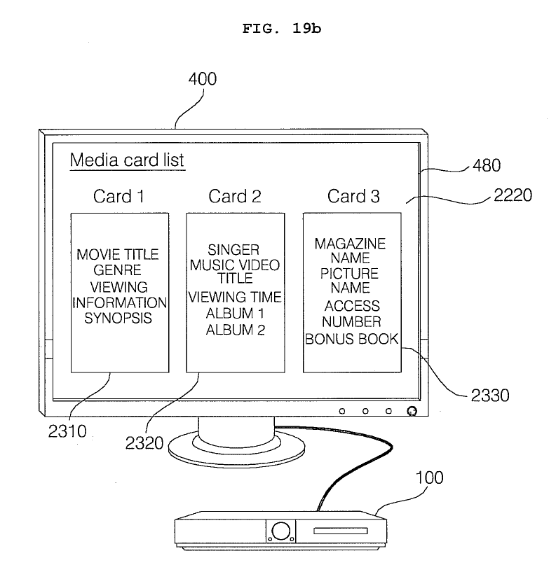

FIG. 18 shows a state in which media card objects 2110, 2120 and 2130 respectively corresponding to the media cars 50a, 50b and 50c are stored in the memory 169.

The memory 169 may be a memory (not shown) included in the NFC module 160 or the memory 140 of the media reproduction apparatus 100.

FIG. 19A shows a state in which an object 2210 indicating whether or not a media card list is displayed is displayed on the display 480 of the image display apparatus 400.

As described above, in order to enter the media card list display mode, as shown in FIG. 19A, the object 2210 indicating whether or not the media card list is displayed may be displayed. By this operation, the media reproduction apparatus 400 may enter the media card list display mode.

FIG. 19B shows a state in which a media card list 2220 is displayed on the display 480 of the image display apparatus 400 according to the media card list display mode.

The media card list 2220 may include media card objects 2310, 2320 and 2330 respectively corresponding to the media cards 50a, 50b and 50c of FIGS. 17(a) to 17(c).

Each of the media card objects 2310, 2320 and 2330 may include at least one of a content type, a content ID, a content title and genre information of the media card. The media card objects 2310, 2320 and 2330 may be generated by the controller 170 based on the content related information of the media card.

In FIG. 19B, the first card object 2310 includes movie title, genre, viewing information and synopsis, the second card object 2320 includes singer, music video title, viewing time, album 1 and album 2, and the third card object 2330 includes magazine name, picture name, access number and bonus book.

Although not shown, the media card objects 2310, 2320 and 2330 may further include at least one of a valid duration of the media card or the content item, the number of times that content can be reproduced or the number of times that content can be downloaded. Thus, it is immediately possible to determine whether the media card or the content item is available.

Although not shown, if the valid duration of the media card or the content item of the media card has expired or the number of times that content can be reproduced or the number of times that content can be downloaded has been exceeded, the media card object or the content item may not be displayed in the media card list 2220 or may be displayed in an inactivated state.

The controller 170 of the media reproduction apparatus 100 may control access to the content server 500 using the media card list information stored in the memory 140. Accordingly, it is possible to periodically check whether the valid duration of the media card in the media card list or the content item of the media card has expired, whether content can be reproduced or whether content can be downloaded. If a media card list display input is received, a media card list may be displayed using available information.

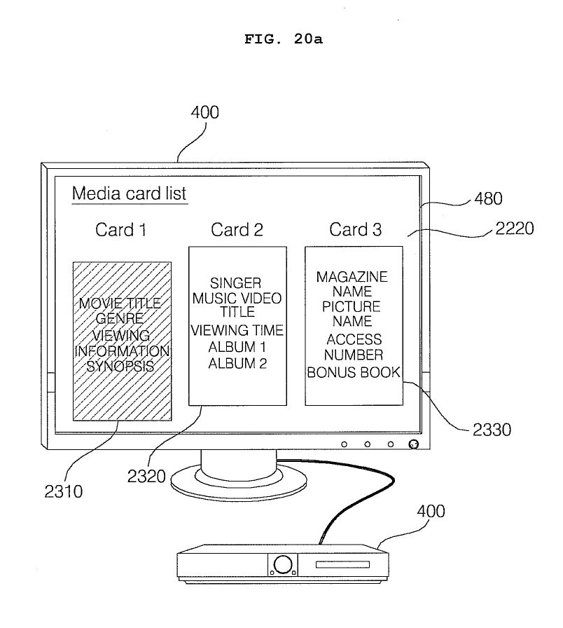

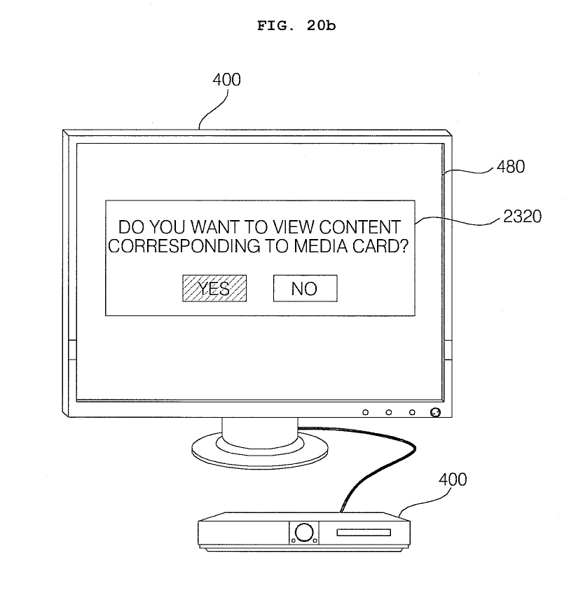

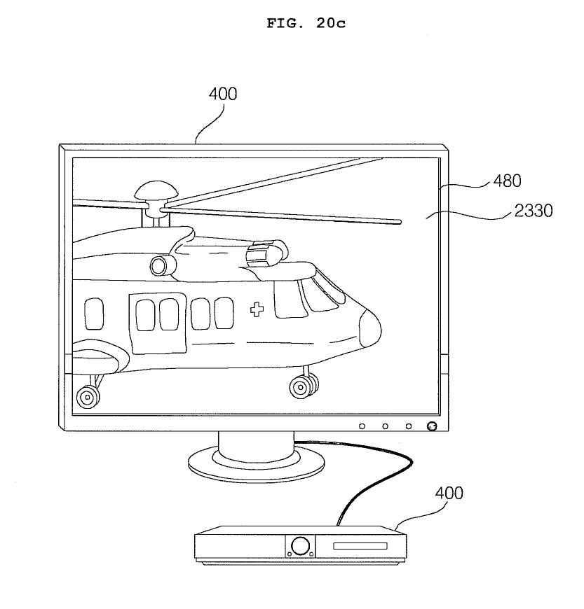

FIG. 20A shows the state in which the first media card object 2310 is selected from the media card list 2220.

By the input of a local key of the media reproduction apparatus 100 or a specific key of the remote controller, the first media card object may be selected from the media card list 2220. The selected first media card object 2310 may be highlighted so as to be distinguished from other media card objects 2320 and 2330.

FIG. 20B shows the state in which an object 2320 indicating whether or not content corresponding to the selected media card is viewed is displayed on the display 480 of the image display apparatus 400.

By input of a local key of the media reproduction apparatus 100 or a specific key of the remote controller, the content corresponding to the selected media card may be set to be viewed.

FIG. 20C shows the state in which the content 2330 corresponding to the selected first media card object 2310 is displayed on the display 480 of the image display apparatus 400.

The controller 170 of the media reproduction apparatus 100 extracts the content server address information corresponding to the selected first media card object 2310 and accesses the content server 500 using the content server address information.

The controller 170 of the media reproduction apparatus 100 reproduces the content received from the content server 500 and displays the content on the display 480 of the image display apparatus 400.

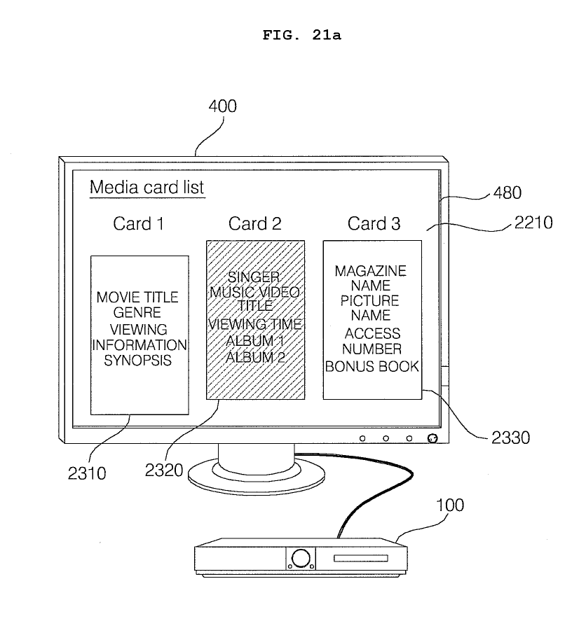

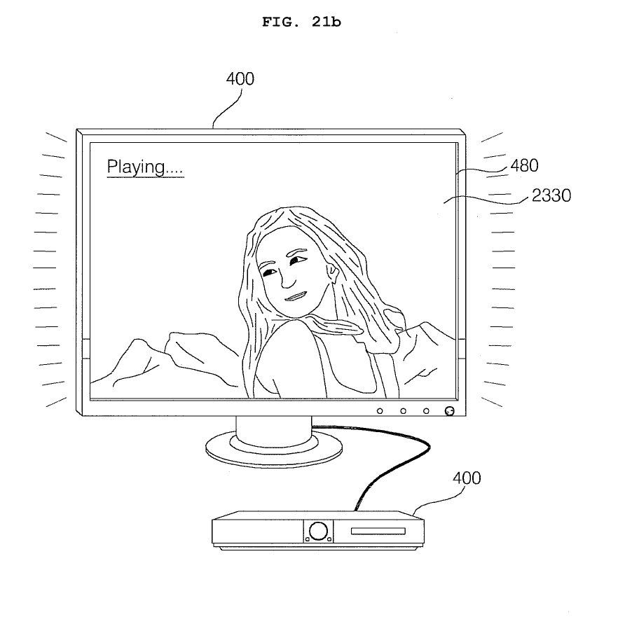

FIG. 21A shows the state in which the second media card object 2320 is selected from the media card list 2220.

By input of a local key of the media reproduction apparatus 100 or a specific key of the remote controller, the second media card object 2312 may be selected from the media card list 2220. The selected second media card object 2320 may be highlighted so as to be distinguished from other media card objects 2310 and 2330.

FIG. 21B shows the state in which content 2340 corresponding to the selected second media card object 2320 is displayed on the display 480 of the image display apparatus 400. In particular, the audio output unit 486 outputs sound.

The controller 170 of the media reproduction apparatus 100 extracts the content server address information corresponding to the selected second media card object 2320 and accesses the content server 500 using the content server address information.

The controller 170 of the media reproduction apparatus 100 reproduces the content received from the content server 500, displays the content on the display 480 of the image display apparatus 400, and outputs the audio data to the audio output unit 485.

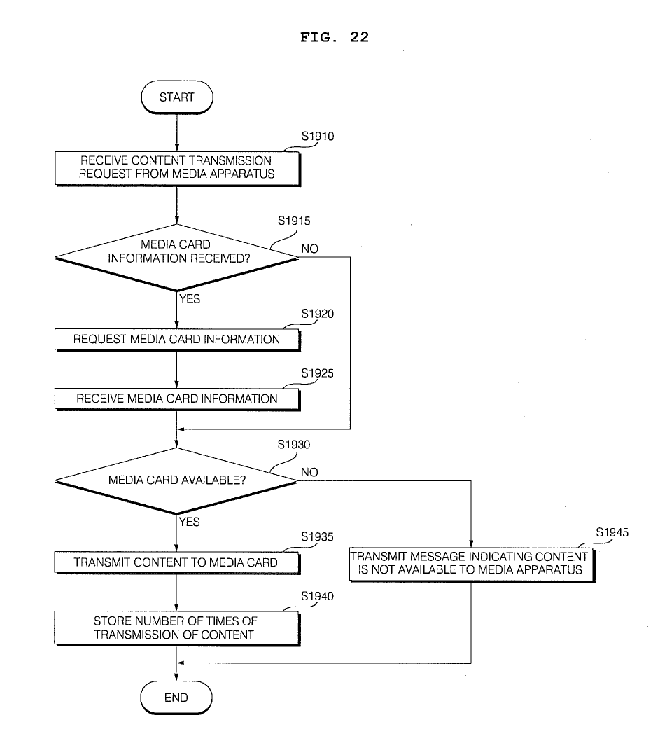

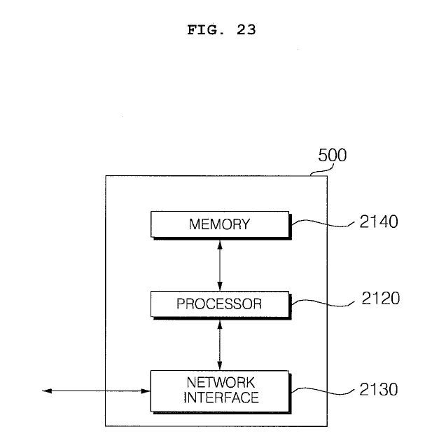

FIG. 22 is a flowchart illustrating a method for operating a content server according to an embodiment of the present invention. FIG. 23 is a block diagram showing the internal configuration of the content server of FIG. 1.

Referring to FIG. 22, the content server 500 receives a content transmission request from the media reproduction apparatus 100 which is a media apparatus (S1910).

As shown in FIG. 20B, if a predetermined media card of a media card list or a predetermined content item of a predetermined media card is selected in a state in which the media card list is displayed on the display 480 of the image display apparatus 400, the media reproduction apparatus 100 may acquire content server address information of the media card or the predetermined content item of the media card.

More specifically, the network interface 135 of the media reproduction apparatus 100 may transmit a content data transmission request signal to the content server 50 over the network 700 based on the extracted final URL information, that is, the content server address information. At this time, information regarding the media reproduction apparatus 100 may also be transmitted.

The content server 500 may receive the content data transmission request signal and the information regarding the media reproduction apparatus 100.

Referring to FIG. 23, the content server 500 may include a network interface 2530, a memory 2540 and a processor 2520.

The network interface 2530 may receive a content transmission request from the media reproduction apparatus 100 and transmit the request signal to the processor 2520.

A determination as to whether media card information is received is made (S1915). If the media card information has not been received, step S1920 is performed and, if the media card information has been received, step S1930 is performed.

The content server 500 and, more particularly, the processor 2520 of the content server 500 may determine whether not only a content data transmission request signal but also media card information has been received.

For example, the media card information may be at least one of “Identifier”, “Relative time”, “Valid-time Duration” and “count” of FIGS. 5 to 7. That is, the media card information may include some of content information of the media card.

The content server 500 and, more particularly, the processor 2520 of the content server 500 may determine whether at least one of the card ID information of the media card (“Identifier”), relative time information (“Relative time”), valid duration of the media card or valid duration information of content download (“Valid-time duration”), or the number of times that content can be reproduced or the number of times that content can be downloaded from the content server (“count”) has been received.

If the above information has not been received, in step S1920, the content server 500 requests media card information from the media reproduction apparatus 100 (S1920) and receives the media card information from the media reproduction apparatus 100 (S1925).

The content server 500 and, more particularly, the processor 2520 of the content server 500 may determine that the media card information is requested from the media reproduction apparatus 100 and transmit the request signal to the network interface 2530 of the content server 500, if at least one of “Identifier”, “Relative time”, “Valid-time duration” or “count” has not been received. The network interface 2530 of the content server 500 requests the media card information from the media reproduction apparatus 100 and receives the media card information from the media reproduction apparatus 100.

Next, a determination as to whether content of the media card is available is made (S1930) and, if the content is available, the content is transmitted to the media reproduction apparatus 100 (S1935). The number of times of transmission of content is then stored (S1940).

The content server 500 may determine whether the media card or the content information of the media card is available based on the received media card information.

For example, the content server 500 and, more particularly, the processor 2520 of the content server 500 may determine whether or not the valid duration of the media card or the content of the media card has expired or whether content can be downloaded using “Relative time” and “Valid-time duration”.

At this time, the ID of the media card may be identified using “Identifier” and a determination as to whether the valid duration of the media card or the content of the media card has expired or whether content can be downloaded is made by media cards.

As another example, the content server 500 and, more particularly, the processor 2520 of the content server 500 may determine whether the number of times that the content of the media card can be reproduced has been exceeded or whether the number of times that content can be downloaded from the content server has been exceeded using “count”.

At this time, the ID of the media card may be identified using “Identifier” and a determination as to whether the number of times that the content of the media card can be reproduced has been exceeded or whether the number of times that content can be downloaded from the content server has been exceeded is made by media cards.

If the media card is available, that is, if the valid duration has not expired or the number of times that content can be downloaded has not been exceeded, the content server 500 and, more particularly, the network interface 2530 of the content server 500 may transmit content to the media reproduction apparatus 100.

The content server 500 and, more particularly, the memory 2540 of the content server 500 store the number of times of transmission of content by media cards. When next content is transmitted, the content server 500 may determine whether the number of times that the content of the media card can be reproduced has been exceeded or whether the number of times that the content can be downloaded from the content server has been exceeded, using the number of times of transmission of content.

The content server 500 may appropriately transmit the content to the media reproduction apparatus 100.

The content server 500 may receive information (serial number, product name, etc.) of the media apparatus, for example, the media reproduction apparatus 100. The content server 500 can identify the media apparatus for requesting transmission of content corresponding to the media card. That is, if different media apparatuses request content transmission using the same media card, the content server 500 may distinguish the media apparatuses from one another.

If the content of the media card is not available in step S1930, a message indicating that the content is not available is transmitted to the media reproduction apparatus 100 (S1945).

The content server 500 and, more particularly, the processor 2520 of the content server 500 transmit the message indicating that the content is not available to the media reproduction apparatus 100 through the network interface 2530 if the content of the media card is not available.

The media reproduction apparatus 100 may receive the message indicating that the content is not available and delete the media card from the media card list or the content item of the media stored in the memory 140.

When the media card list is displayed, the media card of the media card list or the content item of the media card may not be displayed or may be displayed in an inactivated state. Accordingly, the user can conveniently check the available media cards or content items of the media cards.

According to a media apparatus, a content server and a method for operating the same of the present invention are not limited to the configurations and the methods of the above-described embodiments and various modifications may be made by selectively combining all or some of the embodiments.

The method for operating the media apparatus or the method for operating the content server according to the foregoing embodiments may be implemented as code that can be written to a computer-readable recording medium and can thus be read by a processor. The computer-readable recording medium may be any type of recording device in which data can be stored in a computer-readable manner. Examples of the computer-readable recording medium include a ROM, a RAM, a CD-ROM, a magnetic tape, a floppy disc, an optical data storage, and a carrier wave (e.g., data transmission over the Internet). The computer-readable recording medium can be distributed over a plurality of computer systems connected to a network so that computer-readable code is written thereto and executed therefrom in a decentralized manner. Functional programs, code, and code segments needed for realizing the embodiments herein can be construed by one of ordinary skill in the art.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for operating a media apparatus, comprising:
tagging a media card;
receiving content related information from the media card; and
displaying a media card list including a media card object corresponding to the content related information of the media card.

2. The method according to claim 1, wherein the media card list includes a plurality of media card objects if a plurality of media cards is tagged.

3. The method according to claim 1, further comprising storing the content related information from the media card.

4. The method according to claim 1, further comprising:
if a predetermined media card of the media card list or a predetermined content item of a predetermined media card is selected, extracting content server address information based on the content related information of the selected media card or the content related information of the selected content item;
accessing a content server based on the extracted content server address information;
receiving content data from the content server; and
reproducing the received content data.

5. The method according to claim 1, wherein the media card object includes at least one of a content type, a content ID, a content title, and genre information of the media card.

6. The method according to claim 1, wherein, in the displaying of the media card list, if a valid duration of the media card or a content item of the media card has expired or the number of times that content can be reproduced or the number of times that content can be downloaded has been exceeded, the media card object or the content item is not displayed in the media card list or is displayed in an inactivated state.

7. The method according to claim 5, wherein the media card object further includes at least one of valid duration information, information regarding the number of times that content can be reproduced or information regarding the number of times that content can be downloaded of the media card or the content item.

8. The method according to claim 1, wherein, in the displaying of the media card list, the media card list is automatically displayed whenever a media card is tagged and a media card object corresponding to a recently tagged media card in the media card list is highlighted to be distinguished from other media card objects.

9. The method according to claim 1, wherein the displaying of the media card list is performed if a media card list display input is received.

10. A method for operating a content server, comprising:
receiving a content transmission request from a media apparatus over a network;
receiving information regarding a media card capable of communicating with the media apparatus;
determining whether content of the media card is available based on the information regarding the media card and transmitting a message indicating that the content is not available to the media apparatus if the content is not available; and
transmitting the content to the media apparatus if the content of the media card is available.

11. The method according to claim 10, wherein the information regarding the media card includes at least one of ID information of the media card, valid duration information of the media card or information regarding the number of times that the content corresponding to the media card can be reproduced.

12. The method according to claim 10, further comprising receiving information regarding the media apparatus from the media apparatus.

13. A media apparatus comprising:
a near field communication module configured to receive content related information of a media card by tagging the media card; and
a display configured to display a media card list including a media card object corresponding to the media card.

14. The media apparatus according to claim 13, wherein the media card list includes a plurality of media card objects if a plurality of media cards is tagged.

15. The media apparatus according to claim 13, further comprising a memory configured to store the content related information received from the tagged media card.

16. The media apparatus according to claim 13, further comprising:
a controller configured to, if a predetermined media card of the media card list or a predetermined content item of a predetermined media card is selected, extract content server address information based on the content related information of the selected media card or the content related information of the selected content item;
a network interface configured to access a content server based on the content server address information extracted based on the content related information and receive content data from the content server.

17. The media apparatus according to claim 13, wherein, if a valid duration of the media card or a content item of the media card has expired or the number of times that content can be reproduced or the number of times that content can be downloaded has been exceeded, the display does not display the media card object or the content item in the media card list or displays the media card object or the content item in an inactivated state.

18. The media apparatus according to claim 13, wherein the network interface transmits a content transmission request signal corresponding to the media card, information regarding the media apparatus and information regarding the media card to the content server.

19. A content server comprising:
a network interface configured to receive a content transmission request from a media apparatus over a network and receive information regarding a media card capable of communicating with the media apparatus; and
a processor configured to determine whether content of the media card is available based on the information regarding the media card, transmit a message indicating that the content is not available to the media apparatus if the content is not available, and transmit the content to the media apparatus if the content of the media card is available.

20. The content server according to claim 19, wherein the information regarding the media card includes at least one of ID information of the media card, valid duration information of the media card or information regarding the number of times that the content corresponding to the media card can be reproduced.
